(19) United States
(12) Patent Application Publication
(10) Pub. No.: US 2024/0105207 A1
(43) Pub. Date: Mar. 28, 2024

(54) Textless Speech Emotion Conversion Using Discrete and Decomposed Representations

(71) Applicant: Meta Platforms, Inc., Menlo Park, CA (US)

(72) Inventors: Felix KRUK, Rehovot (IL); Yossef Mordechay ADI, Rishon Le Zion (IL)

(21) Appl. No.: 17/860,010

(22) Filed: Jul. 7, 2022

(51) Int. Cl. G10L 25/63; G10L 15/22; G10L 25/90

(52) U.S. Cl. CPC G10L 25/63; G10L 15/22; G10L 25/90; G10L 2015/227

(57) ABSTRACT

In one embodiment, a method includes accessing a speech signal corresponding to a source emotion, generating content units based on the speech signal, generating altered content units for the content units based on a target emotion, determining a respective duration for each of the altered content units based on the target emotion, generating a respective pitch curve for each of the altered content units based on the target emotion and the respective altered duration, and generating an altered speech signal corresponding to the target emotion based on the target emotion, speech characteristics associated with a speaker, the altered content units based on their respective altered durations, and the pitch curves for the altered content units.

### TECHNICAL FIELD

This disclosure generally relates to speech processing, and in particular relates to hardware and software for speech processing.

### BACKGROUND

Speech processing is the study of speech signals and the processing methods of signals. The signals are usually processed in a digital representation, so speech processing can be regarded as a special case of digital signal processing, applied to speech signals. Aspects of speech processing includes the acquisition, manipulation, storage, transfer and output of speech signals.

Speech translation is the process by which conversational spoken phrases are instantly translated and spoken aloud in a second language. This differs from phrase translation, which is where the system only translates a fixed and finite set of phrases that have been manually entered into the system. Speech translation technology enables speakers of different languages to communicate. It thus is of tremendous value for humankind in terms of science, cross-cultural exchange and global business.

### SUMMARY OF PARTICULAR EMBODIMENTS

In particular embodiments, a speech-processing system may use a model for changing emotion in speech signals. With emotion in speech, the error rate for automatic speech recognition (ASR) is usually higher. Therefore, by removing emotion from speech signals, the model may improve automatic speech recognition. On the other hand, the model may also add desired emotion in speech signals to generate expressive speech signals for training speech recognition models that can handle speech signals with emotion. Where to add the desired emotion (e.g., yarns) may be learned based on a probabilistic model. The model may treat changing emotion as a machine translation task wherein the input is a speech utterance with a source emotion and the output is the same utterance with a target emotion. The model may decompose the speech signal into discrete learned representations, comprising phonetic-content units, prosodic features, speaker, and emotion. Then the model may modify the speech content by translating the phonetic content units to a target emotion and predicts the prosodic features based on these units. The speech waveform for the target emotion may be eventually generated by applying a neural vocoder to the predicted representations. Although this disclosure describes particular speech processing in a particular manner, this disclosure contemplates any suitable speech processing in any suitable manner.

In particular embodiments, the speech-processing system may access a speech signal corresponding to a source emotion. The speech-processing system may then generate a plurality of content units based on the speech signal. In particular embodiments, the speech-processing system may generate, based on a target emotion, a plurality of altered content units for the plurality of content units. The speech-processing system may then determine, based on the target emotion, a respective duration for each of the plurality of altered content units. The speech-processing system may then generate, based on the target emotion and the respective altered duration, a respective pitch curve for each of the plurality of altered content units. In particular embodiments, the speech-processing system may further generate an altered speech signal corresponding to the target emotion based on the target emotion, speech characteristics associated with a speaker, the plurality of altered content units based on their respective altered durations, and the plurality of pitch curves for the plurality of altered content units.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example pipeline for speech processing.

FIG. 2 illustrates an example architecture of the sequence-to-sequence emotion translation component Eₛ₂ₛ.

FIGS. 3A-3B illustrate example MOS and eMOC scores for our method and the evaluated baselines.

FIG. 4 illustrates an example confusion matrix for ground-truth recordings.

FIG. 5 illustrates an example confusion matrix for our method.

FIG. 6 illustrates an example confusion matrix for Seq2Seq-EVC.

FIG. 7 illustrates an example confusion matrix for Tacotron2.

FIG. 8 illustrates an example confusion matrix for VAW-GAN.

FIG. 9 illustrates an example method for changing emotion in speech signals.

FIG. 10 illustrates an example computer system.

### DESCRIPTION OF EXAMPLE EMBODIMENTS

In particular embodiments, a speech-processing system may use a model for changing emotion in speech signals. With emotion in speech, the error rate for automatic speech recognition (ASR) is usually higher. Therefore, by removing emotion from speech signals, the model may improve automatic speech recognition. On the other hand, the model may also add desired emotion in speech signals to generate expressive speech signals for training speech recognition models that can handle speech signals with emotion. Where to add the desired emotion (e.g., yarns) may be learned based on a probabilistic model. The model may treat changing emotion as a machine translation task wherein the input is a speech utterance with a source emotion and the output is the same utterance with a target emotion. The model may decompose the speech signal into discrete learned representations, comprising phonetic-content units, prosodic features, speaker, and emotion. Then the model may modify the speech content by translating the phonetic content units to a target emotion and predicts the prosodic features based on these units. The speech waveform for the target emotion may be eventually generated by applying a neural vocoder to the predicted representations. Although this disclosure describes particular speech processing in a particular manner, this disclosure contemplates any suitable speech processing in any suitable manner.

In particular embodiments, the speech-processing system may access a speech signal corresponding to a source emotion. The speech-processing system may then generate a plurality of content units based on the speech signal. In particular embodiments, the speech-processing system may generate, based on a target emotion, a plurality of altered content units for the plurality of content units. The speech-processing system may then determine, based on the target emotion, a respective duration for each of the plurality of altered content units. The speech-processing system may then generate, based on the target emotion and the respective altered duration, a respective pitch curve for each of the plurality of altered content units. In particular embodiments, the speech-processing system may further generate an altered speech signal corresponding to the target emotion based on the target emotion, speech characteristics associated with a speaker, the plurality of altered content units based on their respective altered durations, and the plurality of pitch curves for the plurality of altered content units.

Speech emotion conversion is the task of modifying the perceived emotion of a speech utterance while preserving the lexical content and speaker identity. The embodiments disclosed herein cast the problem of emotion conversion as a spoken language translation task. We may use a decomposition of the speech signal into discrete learned representations, comprising phonetic-content units, prosodic features, speaker, and emotion. First, we may modify the speech content by translating the phonetic-content units to a target emotion, and then predict the prosodic features based on these units. Finally, the speech waveform may be generated by feeding the predicted representations into a neural vocoder. Such a paradigm may allow us to go beyond spectral and parametric changes of the signal, and model non-verbal vocalizations, such as laughter insertion, yawning removal, etc. We demonstrate objectively and subjectively that our method disclosed herein is more advantageous over conventional approaches and even beat text-based systems in terms of perceived emotion and audio quality. We rigorously evaluate all components of such a complex system and conclude with an extensive model analysis and ablation study to better emphasize the architectural choices, strengths and other aspects of our method.

Generating spoken utterances and dialogue that sound natural may be a requirement to improve human-computer interaction. One of the main roadblocks in improving naturalness in speech generation may be the modeling of expressive and emotional states. The difficulty may be that emotion is a phenomenon affecting all linguistic levels simultaneously: when one goes from a happy to an angry state, one may use different vocabulary, insert non-verbal vocalizations (cries, grunts, etc.), modify prosody (intonation and rhythm), and change voice quality due to stress. Vice versa each of the levels may contribute to the perception of the emotional state of the speaker, where the nonverbal aspects may often override the lexical content.

Existing emotion generation or emotion conversion techniques may have a hard time producing convincing results because they may only manage to tackle a subset of these levels. In a nutshell, signal-based approaches may be mainly focused on manipulating parameters of the speech signal and may only address changes at the level of voice and prosody. In contrast, text-based approaches may generate expressive speech, but struggle with nonverbal vocalizations because they are typically not annotated in speech corpora.

The embodiments disclosed herein focus on the task of speech emotion conversion under the parallel dataset setting, modifying the perceived emotion of a speech utterance while preserving the speaker identity and the lexical content.

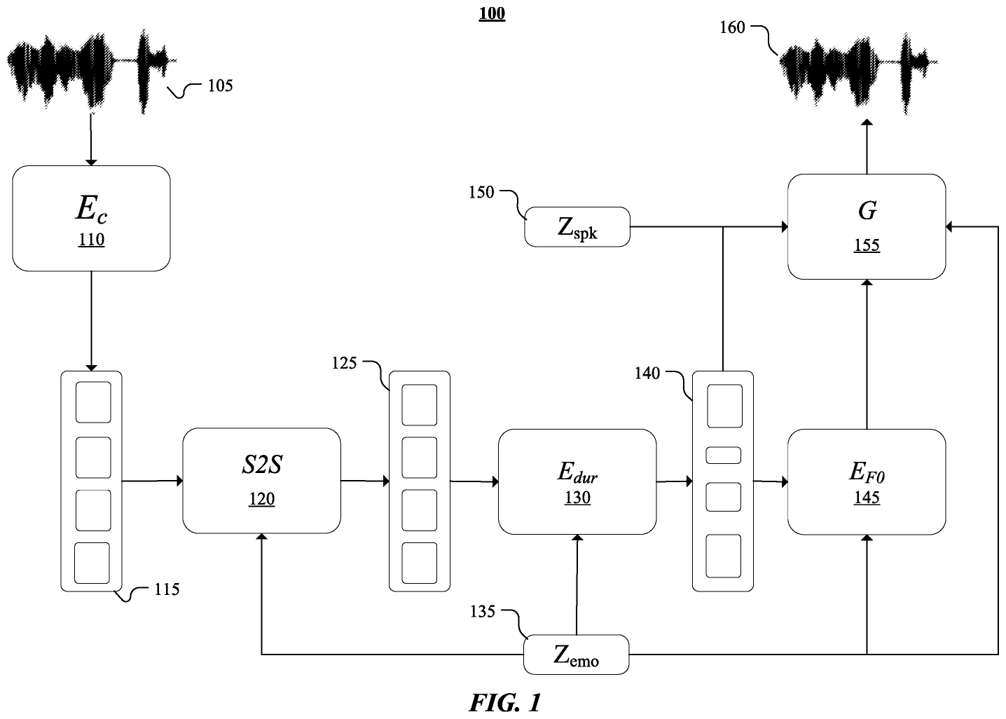

The pipeline for speech processing based on the embodiments disclosed herein may comprise four main blocks: speech tokenizer, content translation model, prosody prediction model, and a neural vocoder. We may start by extracting discrete representation of the speech signal. In particular embodiments, the speech signal may be associated with the speaker. The speech-processing system may generate the speech characteristics for the speaker based on the speech signal. We may translate the representation to a target emotion while preserving the lexical content (e.g., removing laughter content, inserting yawning content). Then, we may predict prosodic features based on the translated representations. A neural vocoder may synthesize the speech waveform from the translated phonetic content, predicted prosody, speaker label and target emotion label. FIG. 1 illustrates an example pipeline 100 for speech processing. The input signal 105 may be first encoded as a discrete sequence of content units 115 based on a content encoder E_{c} 110. Next, a sequence to sequence (S2S) model 120 may be applied to translate between the sequences corresponding to different emotions, which may be conditioned by emotion Zₑₘₒ 135. As an example and not by way of limitation, the input to the S2S model 120 may be a discrete sequence of content units 115 based on a source emotion and its output may be a discrete sequence of content units 125 based on a target emotion. Then we may predict the duration 140 using on a duration prediction model E_{chur} 130, conditioned by the emotion Z. 135. Then we may predict the pitch using an F0 estimation model E_{F0} 145, also conditioned by the emotion Zₑₘₒ 135. The speaker identity zₛₚₖ 150, predicted duration 140, predicted pitch, and the emotion (Zₑₘₒ) 135 may be fed into a vocoder (G) 155, which may generate the output waveform 160.

The contribution of the embodiments disclosed herein may be twofold: We disclose a novel textless approach by casting the task of speech emotion conversion as a spoken language translation problem. We demonstrate how such a paradigm may be used to model expressive non-verbal communication cues as well as generating high-quality speech samples. Finally, we demonstrate for the first time the coverage of all levels of expressive speech modeling simultaneously.

The experimental results show that our method is advantageous over emotion conversion techniques based on signal only, and also beat text-based approaches in terms of generation quality and perceived emotion. We conduct an extensive evaluation of the modules composing our system and conclude with an ablation study to better understand the effect of each component of the decomposition on the overall generated speech.

As emotion may manifest itself in multiple aspects of spoken language, to optimally convert emotion one may need to consider all aspects in the conversion process. In particular embodiments, the source or target emotion may be based on one or more of a prosodic feature, a speaking style, or a non-verbal vocalization. As an example and not by way of limitation, emotion may be expressed via prosodic features (high pitch, slow speaking rate, etc.), speaking style (yelling, whispering, etc.), and non-verbal vocalizations (laughing, yawning, crying, etc.).

The embodiments disclosed herein may use a decomposed representation of the speech signal to synthesize speech in the target emotion. We may consider four components in the decomposition: phonetic-content, prosodic features (i.e., F0 and duration), speaker identity, and emotion-label, denoted by z_{c}, (zdur, zF0), zspk, zemo respectively.

Specifically, the embodiments disclosed herein may be based on the following cascaded pipeline: (i) extract z_{c} from the raw waveform using a self-supervised learning (SSL) model; (ii) translate non-verbal vocalizations in z_{c} while preserving the lexical content (e.g., when converting from amused to sleepy, we may remove laughter and insert yawning); in other words, generating the plurality of altered content units may comprise translating non-verbal vocalizations associated with the speech signal while preserving lexical content associated with the speech signal; (iii) predict the prosodic features of the target emotion based on the translated content; (iv) synthesize the speech from the translated content, predicted prosody, target speaker identity and target emotion-label.

To represent speech phonetic content we may extract a discrete representation of the audio signal using a pre-trained SSL model, namely HuBERT. We may use an SSL representation for phonetic content in order to capture nonverbal vocalizations (unlike text where they may be often not annotated). We may discretize this representation for better modeling and sampling (as opposed to regressing on continuous variables). This paradigm may allow us to benefit from all recent advances in natural language processing (NLP).

Denote the domain of audio samples by X⊂R. The representation for an audio waveform may be therefore a sequence of samples x=(x¹, . . . , x^{T}), where each xⁱ∈X for all 1<τ<T. The content encoder E_{c} may be a HuBERT model pre-trained on an experimental speech corpus. HuBERT is a self-supervised model trained on the task of masked prediction of continuous audio signals, similarly to BERT. During training, the targets may be obtained via clustering of MFCCs features or learned representations from earlier iterations. In particular embodiments, the speech signal may be based on an audio waveform. Correspondingly, generating the plurality of content units may comprise applying an encoder to the audio waveform. The input to the content encoder E_{c} may be an audio waveform x, and the output may be a spectral representation sampled at a lower frequency z′=(z′_{c}¹, . . . , z′_{c}^{L}) where L<T. In other words, the encoder may output a continuous spectral representation of the speech signal. In particular embodiments, the speech-processing system may apply a clustering algorithm to the continuous spectral representation based on a size of a vocabulary associated with the speech signal. Since HuBERT outputs continuous representations, an additional k-means step may be needed in order to quantize these representations into a discrete unit sequence denoted by z_{c}=(z_{c}¹, . . . , z_{c}^{L}) where z_{c}ⁱϵ{1, . . . , K} and K may be the size of the vocabulary. For the rest of this disclosure, we refer to these discrete representations as “units”. We may extract representations from the 9-th layer of HuBERT model and set k=200. In particular embodiments, repeated units may be omitted (e.g., 0, 0, 0, 1, 1, 2−+0, 1, 2). We denote such sequences by “deduped”. We may use HuBERT for the phonetic-content units as it may better disentangle between speech content and both speaker and prosody compared to other SSL-based models.

The embodiments disclosed herein may convert speech emotion while keeping the speaker identity fixed. To that end, we may construct a speaker-representation zₛₚₖ, and include it as an additional conditioner during the waveform synthesis phase. To learn zₛₚₖ we may optimize the parameters of a fixed size look-up-table. Although such modeling may limit our ability to generalize to new and unseen speakers, it may produce higher quality generations. We additionally experimented with representing zₛₚₖ as a d-dimensional vector. However, we observed that such approach keeps source emotion prosodic features, resulting in inferior disentanglement during the waveform synthesis phase.

We may represent the emotion-label using a categorical variable represented by a 1-hot vector. We observed that this component controls for timbre characteristics of the generated speech signal (e.g., roughness, smoothness, etc.) during the synthesis phase.

Using the aforementioned representations, the embodiments disclosed herein may synthesize the speech signal in the target emotion. We may use a translation model to convert between phonetic-content units of a source emotion to phonetic-content units of the target emotion. This may serve as a learnable insertion/deletion/substitution mechanism for nonverbal vocalizations, while preserving the lexical content (e.g., removing yawning while preserving the verbal content). Next, we may predict the prosodic features (duration and F0) based on the translated phonetic-content units and target emotion-label and inflate the sequence according to the predicted durations. This may later be used as a conditioning for the waveform synthesis phase.

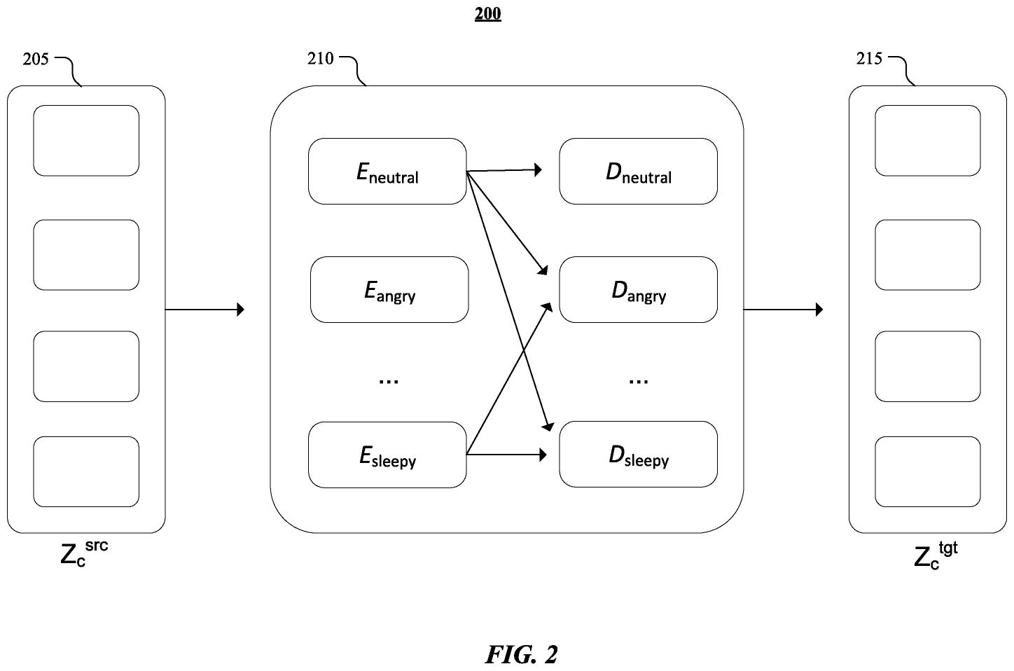

To translate the speech content units, we may use a sequence-to-sequence transformer model denoted by Eₛ₂ₛ. FIG. 2 illustrates an example architecture 200 of the sequence-to-sequence emotion translation component Eₛ₂ₛ 210. In particular embodiments, generating the plurality of altered content units may be based on a sequence-to-sequence model. Here different encoders and decoders may be used for each emotion, but we also tested shared architectures, which would be disclosed later in this disclosure. In one embodiment, the sequence-to-sequence model may comprise one encoder shared among a plurality of source emotions comprising the source emotion and one decoder shared among a plurality of target emotions comprising the target emotion. In another embodiment, the sequence-to-sequence model may comprise a plurality of encoders dedicated to a plurality of source emotions comprising the source emotion, respectively. The sequence-to-sequence model may comprise a plurality of decoders dedicated to a plurality of target emotions comprising the target emotion, respectively. In yet another embodiment, the sequence-to-sequence model may comprise one encoder shared among a plurality of source emotions comprising the source emotion. The sequence-to-sequence model may comprise a plurality of decoders dedicated to a plurality of target emotions comprising the target emotion, respectively. The input to Eₛ₂ₛ 210 may be a sequence of phonetic-content units 205 representing a speech utterance in the source emotion z_{c}^{src}. The model may be trained to output a sequence of phonetic-content units z_{c}^{tgt} 210 comprising the same lexical content with the addition/deletion/substitution of speech cues related to emotion expression (e.g., inserting laughter units). In other words, generating the plurality of altered content units may comprise one or more of changing a content unit of the plurality of content units, adding a content unit to the plurality of content units, or deleting a content unit from the plurality of content units. The optimization may minimize the cross-entropy (CE) loss between the predicted units z_{c}=Eₛ₂ₛ (z_{c}^{src}, Zₑₘₒ) and ground-truth units for each location in the sequence as,

$$\\ \begin{matrix}{L}_{s 2 s} = {\sum }_{i = 1}^{L} CE ( {{E}_{s 2 s} ( {z}_{c}^{src} , {z}_{emo} )}_{i} , {{z}_{c}^{tgt}}_{i} ) . & ( 1 )\end{matrix}$$

In the experiments, we observed that directly optimizing the above model for translation may capture emotion transfer, but may fail to maintain the same lexical content, producing expressive yet unintelligible speech utterances (e.g., the model may add laughter but corrupt the sentence by removing needed syllables). To mitigate this, we may pre-train the translation model on the task of language denoising auto-encoder similarly to BART. To better support translation between all emotions we may use a dedicated encoder and decoder for each emotion (see FIG. 2). We additionally evaluated a shared-encoder and shared-decoder model, in which we condition on the target emotion, as well as a model where only the encoder is shared. We evaluated all approaches with results are summarized.

Next, using the translated phonetic-content unit sequence we may predict the prosodic features corresponding to the target emotion. We may consider the prosodic representation as a tuple of content unit durations and F0.

We may start by describing the duration prediction process. Due to working on deduped sequences, we may first need to predict the duration of each phonetic-content unit. We may use a convolutional neural network (CNN) to learn the mapping between content units to durations. We denote this model by E_{dur}. During training of E_{dur}, we may input the deduped phonetic-content units z_{c} and use the ground-truth phonetic-content unit durations as supervision. We minimize the mean squared error (MSE) between the network's output and the target durations. We also evaluated n-gram-based duration prediction models. The n-gram models were trained by counting the mean frequency p and the standard deviation σ of each n-gram in the training set. During inference, we predict the duration of each n-gram by sampling from N(μ, σ). For unseen n-grams we back-off to a smaller n-gram model.

We now turn to describe the F0 prediction process. We may use an F0 estimation model to predict the pitch from a sequence of phonetic-content units z_{c}. Our model, denoted by E_{F0}, may be a CNN, followed by a linear layer projecting the output to [symbol] ^{d}. The final activation layer may be set to be a sigmoid such that the network outputs a vector in [0, 1] ^{d}. We may extract the F0 using the YAAPT algorithm to serve as targets during training. Next, we may normalize the F0 values using the mean and standard deviation per speaker. We may discretize the range of F0 values into d bins represented by one-hot encodings. Next, we may apply Gaussian-blur on these encodings to get the final supervision targets denoted by z_{F0}=(z_{F0}¹, . . . , z_{F0}^{T}) where each z_{F0}ⁱ ∈[0,1] ^{d} and d=50. Formally, we may minimize the binary-cross-entropy (BCE) for each coordinate of the target and the network output as

L_{F0}=Σᵢ₌₁^{d}BCE(E_{F0}(z_{c},Zₑₘₒ^{tgt})ᵢ,z_{F0}ⁱ). (2)

During inference multiple frequency bins may be activated to a different extent. We may output the F0 value corresponding to the weighted average of the activated bins. This modeling may allow for a better output range when converting bins back to F0 values, as opposed to a single representative F0 value per bin. For F0-to-bin conversion, we may use an adaptive binning strategy such that the probability mass of each bin is the same. For completeness, we explored uniform binning, results are summarized later in this disclosure. Additional log-F0 estimation results would be presented later in this disclosure.

Notice that the mapping between discrete unit sequences and prosodic feature (F0 and durations) may be one-to-many, as it may depend on the target emotion. Hence, we may additionally condition both E_{dur} and E_{F0} on the target emotion denoted by Zₑₘₒ^{tgt}. Both models may be trained independently.

We may use a variation of the HiFi-GAN neural vocoder. The architecture of HiFi-GAN comprises a generator G and a set of discriminators D. We may adapt the generator component to take as input a sequence of predicted phonetic-content units inflated using the predicted durations, predicted F0, target speaker-embedding, and a target emotion-label. The above features may be concatenated along the temporal axis and fed into a sequence of convolutional layers that output a 1-dimensional signal. The sample rates of unit sequence and F0 may be matched by means of linear interpolation, while the speaker-embedding and emotion-label may be replicated.

The discriminators may comprise two sets: multi-scale discriminators (MSD) and multi-period discriminators (MPD). The first type may operate on different sizes of a sliding window over the signal (2, 4), while the latter may sample the signal at different rates (2, 3, 5, 7, 11). Overall, each discriminator Dᵢ may be trained by minimizing the following loss functions

$$\\ \begin{matrix}{L}_{adv} ( {D}_{i} , G ) = {\sum }_{x} {‖ 1 - {D}_{i} ( \hat{x} ) ‖}_{2}^{2} & ( 3 )\end{matrix}$$

$$\\ {L}_{D} ( {D}_{i} , G ) = {\sum }_{x} {‖ 1 - {D}_{i} ( x ) ‖}_{2}^{2} + {‖ {D}_{i} ( \hat{x} ) ‖}_{2}^{2}$$

where \hat{x}=G( [symbol] , E_{F0}( [symbol] , Zₑₘₒ), zₛₚₖ, Zₑₘₒ) is the time-domain signal reconstructed from the decomposed representation. There may be two additional loss terms used for optimizing G. The first may be a mean-absolute-error (MAE) reconstruction loss in the log-mel frequency domain L_{recon}(G) Σₓ∥Ø(x)−Ø(\hat{x})∥₁ where Ø is the spectral operator computing the Mel-spectrogram. The second loss term may be a feature matching loss, which penalizes for large discrepancies in the intermediate discriminator representations, ΣₓΣⱼ₌₁^{R}∥ξⱼ(x)−ξⱼ(\hat{x})∥₁ where ξj is the operator that extracts the intermediate representation of the j-th layer of discriminator Dᵢ with R layers. The overall objective for optimizing the system may be:

$$\\ \begin{matrix}{L}_{G} ( D , G ) = [ {\sum }_{i = 1}^{J} {L}_{adv} ( {D}_{i} , G ) + {λ}_{fm} {L}_{fm} ( {D}_{i} , G ) ] + {λ}_{r} {L}_{recon} ( G ) , & ( 4 )\end{matrix}$$

$$\\ {L}_{D} ( D , G ) = {\sum }_{i = 1}^{J} {L}_{D} ( {D}_{i} , G )$$

$$\\ where {λ}_{fm} = 2 and {λ}_{r} = 45.$$

The embodiments disclosed herein use an experimental emotional voices database for training and evaluating our model. The experimental emotional voices database consists of 7000 speech utterances. Each transcript was recorded in multiple acted emotions (neutral, amused, angry, sleepy, disgusted) by multiple native speakers (two male speakers and two female speakers). This may allow us to create a dataset of utterance pairs for the task of translation. Specifically, we create pairs of utterances that are based on the same transcript but are recorded with different acted emotions. Due to the small size of this dataset (˜9 hours), we further augment it by creating additional parallel pairs from different speakers. Overall, the size of the entire dataset is 78,324 pairs. We split the data to train/validation/test sets with a ratio of 90/5/5 such that there is no overlap of utterances between the sets. In our experiments, splitting randomly (e.g., overlapping transcripts) led to a memorization of the utterances and failed to generalize to unseen data.

In particular embodiments, the training data may comprise speech data with the same content but in different emotions. The speech data may be from different speakers. Each component, i.e., the content encoder 110, the sequence-to-sequence model 120, the duration prediction model 130, the F0 estimation model 145, and the vocoder 155, may be trained separately. Then each of the trained components may be combined to attain the pipeline 100 for speech processing.

In particular embodiments, the pipeline 100 may have different use cases. In one use case, the pipeline 100 may be used to improve automatic speech recognition (ASR) by pre-processing an utterance to neutralize it (e.g., removing emotions). Alternatively, the pipeline 100 may be used to generate training data with emotions from neutral training data. The training data with emotions may be then used to train an ASR model. Another use case may be to use the pipeline 100 to change the emotion of an utterance. As an example and not by way of limitation, an application may select a target emotion and process the input speech signal using the pipeline 100 while the speaker may be pre-determined or generated.

We use the sequence-to-sequence transformer model as implemented in fairseq for the experiments. The model contains three layers for both encoder and decoder modules, four attention heads, embedding size of 512, FFN size of 512, and dropout probability of 0.1. For pre-training, we use a mix of the experimental speech corpus, experimental audiobook recordings and the experimental emotional voices database, and stop after 3M update steps. We use the following input augmentations: Infilling using λ, =3.5 for the Poisson distribution, Token masking with probability of 0.3, Random masking with probability of 0.1, and Sentence permutation. Finally, we fine-tune this model on the task of translation using paired utterances of different emotions from the experimental emotional voices database and early-stop using the loss from equation (1). Our F0 prediction model E_{F0} comprises six 1-D convolutional layers, where the number of kernels per layer is 256 and the respective kernel size is 5. For non-linearity we used the ReLU activation function followed by layer-norm and dropout (p=0.1). Our duration prediction model Eau, comprises two convolutional layers, where the number of kernels per layer is 256 and the respective kernel size is 3. For non-linearity we used the ReLU activation function followed by layer-norm and dropout (p=0.5). All experiments in the embodiments disclosed herein are conducted using 8 GPUs with 32 GB memory each.

We compare our method to a text-less speech emotion conversion method, VAW-GAN, as well as a state-of-the-art (SOTA) text-based emotional voice conversion model, Seq2seq-EVC. We also evaluate an expressive text-to-speech (TTS) system based on Tacotron2. We consider text-based systems as ones using textual annotations during training.

For the text-based approach we use the Tacotron2 and Seq2seq-EVC models. The input to Tacotron2 is the ground-truth text representing the speech content. We modify the Tacotron2 architecture by adding a global-style-token to control for the target emotion. The inputs to Seq2seq-EVC are the ground-truth phonemes coupled with the source speech utterance. The output of both systems is the Mel-spectrogram of the speech utterance in the target emotion. To reconstruct the time-domain signal we use the HiFi-GAN vocoder. All baselines were trained and evaluated on the experimental emotional voices database. Seq2seq-EVC and Tacotron2 were first pre-trained on an experimental voice cloning dataset.

For speech emotion conversion, the embodiments disclosed herein use a new subjective metric called emotion-mean-opinion-classification (eMOC). In an eMOC study, a human rater is presented with a speech utterance and a set of emotion categories. The rater is instructed to select the emotion that best fits the speech utterance. As an example and not by way of limitation, for the eMOC, raters were asked: “Select the emotion for the given emotion categories that best suits the given speech utterance”. All raters are native English speakers located in the United States. The eMOC score is the percentage of raters that selected the target emotion given a speech recording. The final score is averaged over all raters and utterances in the study. Additionally, we measure the perceived audio-quality using the mean-opinion-score (MOS). As an example and not by way of limitation, for the MOS metric, raters were asked: “Rate the quality and naturalness of the given speech utterance on a scale of 1 to 5 (1 being of low quality and naturalness and 5 being of high quality and naturalness)”. All raters are native English speakers located in the United States. For “amused”, “angry”, “disgusted” and “sleepy” we used samples converted from “neutral”. The CrowdMOS package was used in all subjective experiments with the recommended recipes for outlier removal. Participants were recruited using a crowd-sourcing platform.

The embodiments disclosed herein perform speech emotion conversion while preserving the lexical content of the speech signal. However, to compare different translation models with different vocabularies, one may not simply use metrics such as BLEU. Hence, we report word error rate (WER) and phoneme error rate (PER) metrics extracted using a pre-trained SOTA ASR system. We use a BASE wav2vec 2.0 phoneme detection model trained on 960 hours of the experimental speech corpus with CTC loss from scratch. As ASR models may suffer from performance degradation when evaluated on expressive speech, WER and PER metrics are reported on emotions converted to neutral: {amused, angry, sleepy, disgusted}-neutral.

We first tune independently the different components of our system using objective metrics: the content-unit extraction configuration and the prosodic modeling modules (F0 and duration estimators). Next, we conduct a subjective evaluation for our best system in terms of audio-quality (MOS) and perceived emotions (eMOC) and compare our method against the baselines. Finally, we run an ablation study where we measure the impact of each component on the perceived emotion.

Intermediate HuBERT representations obtained from different layers may have an impact on the downstream task at hand. The number of units (k) may also have an impact on the overall performance of the system. To better understand the effect of these architectural configurations in our setting, we experimented with extracting HuBERT features from layers 6 and 9, using 100 and 200 clusters for the k-means post-processing step. Additionally, we measure the impact that pre-training the translation model has on performance. As we compare models with different vocabulary sizes, we may not use metrics such as BLEU. Hence, we report WER and PER. Results are in Table 1.

TABLE 1
Evaluation of different token extraction configurations and the effect
of pre-training the translation model. # units denotes the
vocabulary size and layer no. denotes the layer index used in HuBERT.

| # units | layer no. | pre-trained | WER | PER |
|---|---|---|---|---|
| 100 | 6 | X | 88.85 | 72.17 |
| 100 | 6 | ✓ | 36.01 | 29.67 |
| 100 | 9 | X | 83.72 | 66.63 |
| 100 | 9 | ✓ | 31.69 | 27.90 |
| 200 | 6 | X | 91.06 | 77.14 |
| 200 | 6 | ✓ | 31.97 | 27.49 |
| 200 | 9 | X | 84.92 | 71.45 |
| 200 | 9 | ✓ | 23.92 | 25.95 |

For emotion conversion, we find that using the 9-th HuBERT layer and 200 tokens performs best. It may be seen that without pre-training all models fail to generate intelligible speech. This may be due to limited number of parallel emotion training pairs. An evaluation of different model design architectures would be disclosed later in this disclosure.

We evaluate the F0 estimation model using the mean absolute error (MAE) between ground-truth F0 and predicted F0. In this experiment, we explore a number of configurations for training such an estimator. Specifically, we evaluate different binning strategies, normalization methods and prediction rules. For binning strategies, we explore adaptive binning versus uniform binning. Under normalization, we explore no normalization, mean normalization and mean and standard deviation normalization (the mean and standard deviation are computed using the F0 values per speaker). Finally, in addition to the weighted-average prediction rule described in previously, we also evaluate an argmax prediction rule where the highest scoring bin is predicted. Results are summarized in Table 2. Results may suggest that the weighted-average prediction rule is preferable to argmax, especially when used in conjunction with adaptive binning. This may be explained by large-range bins in the adaptive case, leading to larger MAE when selecting a single bin using the argmax operator. Although adaptive quantization reaches the best performance, under specific settings uniform quantization may reach comparable results. For normalization, it may be preferable to normalize as the specific normalization method may have little impact on performance.

TABLE 2
Evaluation of different F0 estimation configurations.
The MAE is reported for voiced frames only.

| Quantization | Norm. | Prediction | MAE |
|---|---|---|---|
| uniform | X | argmax | 83.51 |
| uniform | X | w-avg | 44.92 |
| uniform | mean | argmax | 53.74 |
| uniform | mean | w-avg | 35.63 |
| uniform | mean-std | argmax | 63.01 |
| uniform | mean-std | w-avg | 35.69 |
| adaptive | X | argmax | 129.7 |
| adaptive | X | w-avg | 45.21 |
| adaptive | mean | argmax | 127.8 |
| adaptive | mean | w-avg | 36.06 |
| adaptive | mean-std | argmax | 155.7 |
| adaptive | mean-std | w-avg | 35.38 |

Next, we evaluate the duration prediction models using the MAE between target and predicted durations. For a more complete analysis, we also report the accuracy using thresholds of Oms, 20 ms and 40 ms. We explore a CNN duration predictor and three n-gram based models. The results are summarized in Table 3. As expected, the CNN outperforms n-gram models, with ˜94% accuracy when considering a tolerance level of 40 ms.

TABLE 3
Evaluation of four duration prediction models.

| Model | MAE | Acc@0 ms | Acc@20 ms | Acc@40 ms |
|---|---|---|---|---|
| CNN | 0.77 | 51.12 | 86.24 | 94.08 |
| 1-gram | 1.47 | 29.41 | 67.34 | 83.26 |
| 3-gram | 1.16 | 36.78 | 76.04 | 88.32 |
| 5-gram | 1.02 | 37.32 | 81.36 | 90.46 |

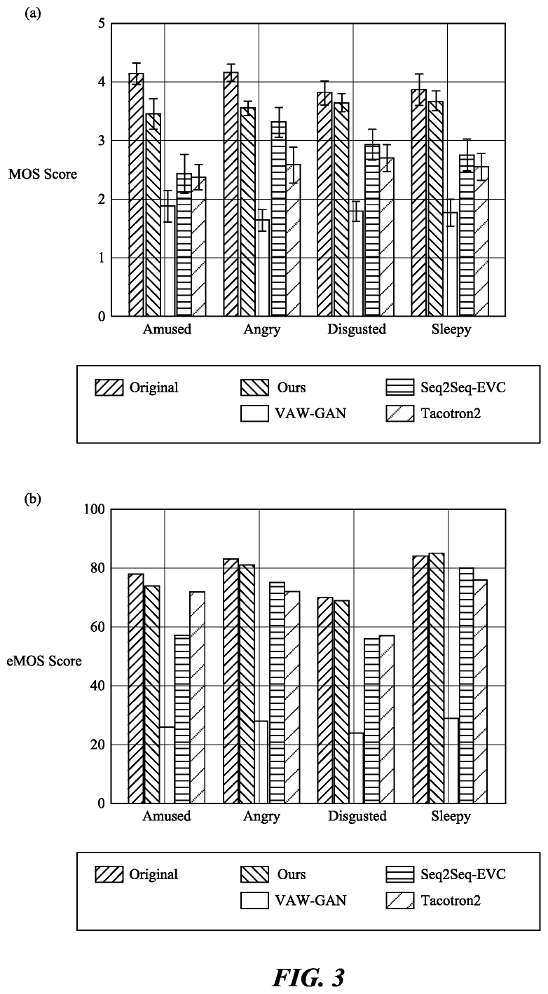

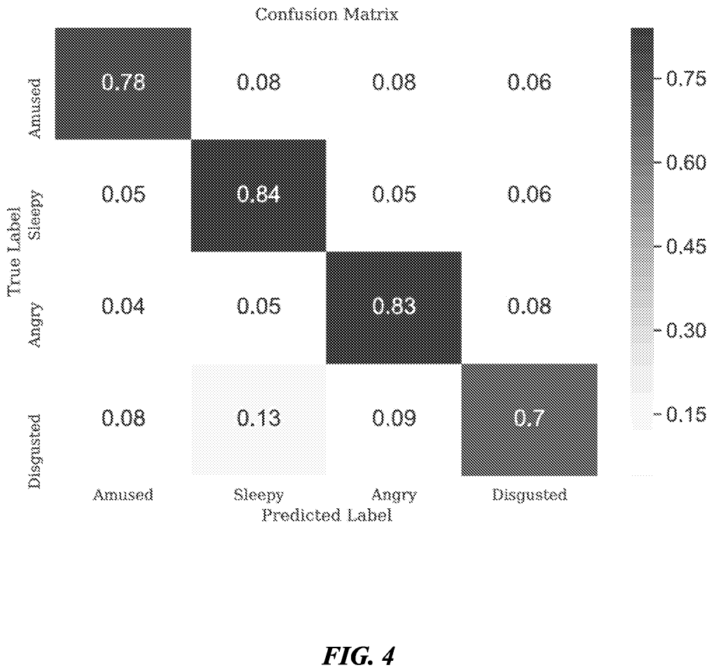

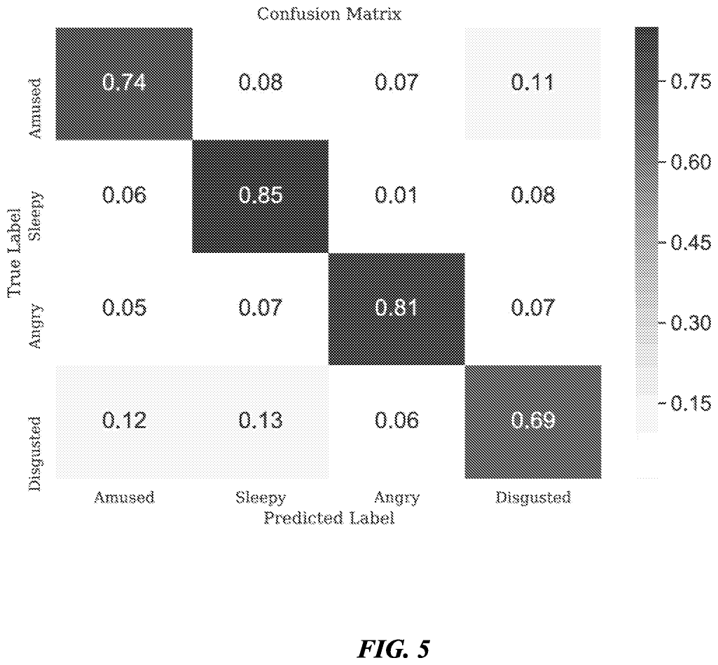

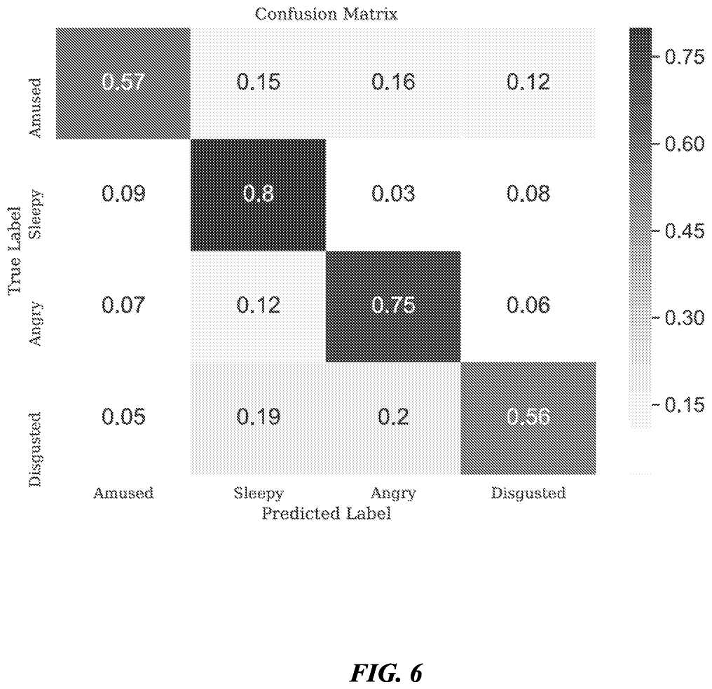

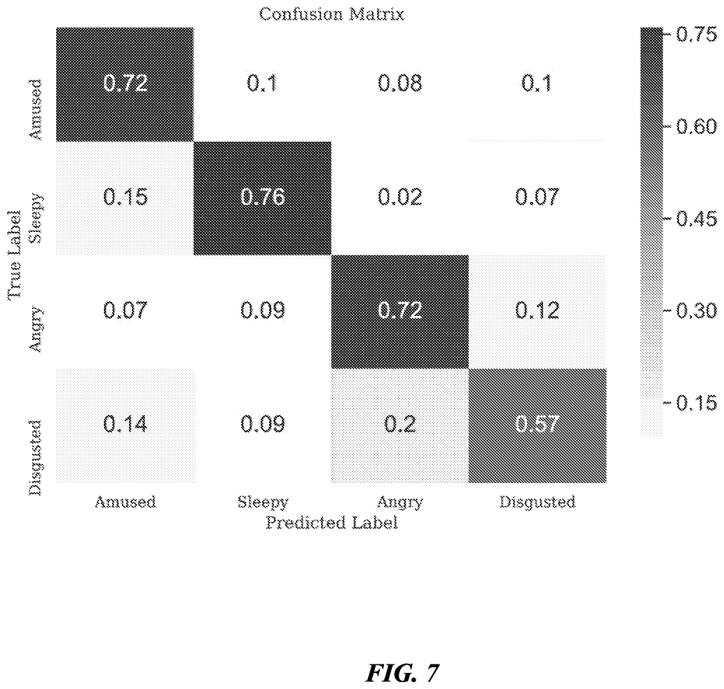

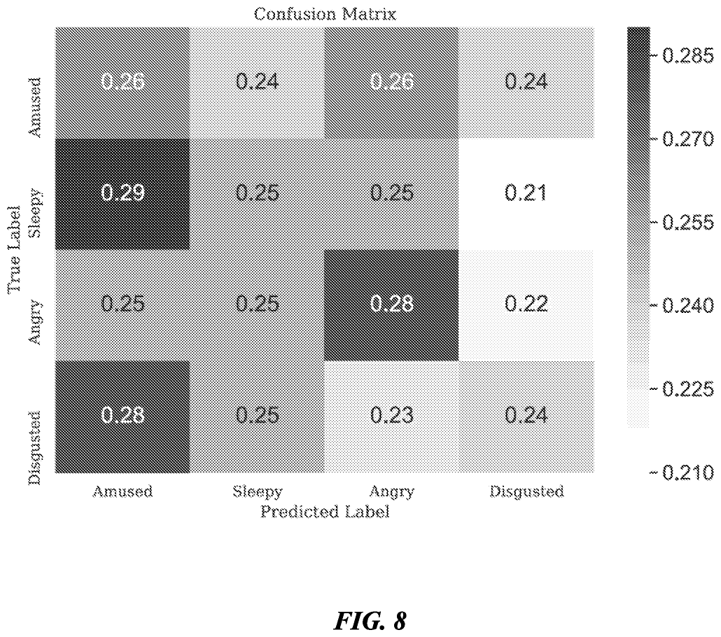

FIGS. 3A-3B illustrate example MOS and eMOC scores for our method and the evaluated baselines. FIG. 3A reports the mean-opinion-score (MOS), measuring the perceived audio-quality. We report mean scores with a confidence interval of 95%. FIG. 3B reports the emotion-mean-opinion-classification (eMOC) score, measuring the perceived emotion. We report mean scores for each emotion (chance level: 25%). Results may suggest that our method surpasses the baselines in terms of both MOS and eMOC. While Tacotron2 and Seq2seq-EVC may succeed in conveying the target emotion, they may produce less natural expressive speech utterances, which is reflected in lower MOS. Unlike our method, both Tacotron2 and Seq2seq-EVC are text-based systems. Hence, they may attempt to learn an alignment (an attention map) between text inputs and audio targets. This task may be particularly challenging as nonverbal cues (e.g., laughter, breathing) may be not annotated in the text inputs. We may hypothesize that this misalignment may lead to less natural expressive speech production. We additionally provide eMOC confusion matrices for the proposed method, evaluated baselines, and ground truth recordings. FIG. 4 illustrates an example confusion matrix for ground-truth recordings. FIG. 5 illustrates an example confusion matrix for our method. FIG. 6 illustrates an example confusion matrix for Seq2Seq-EVC. FIG. 7 illustrates an example confusion matrix for Tacotron2. FIG. 8 illustrates an example confusion matrix for VAW-GAN.

Recall that the embodiments disclosed herein may use a decomposed speech representation comprising four feature sets. In particular embodiments, we may gauge the effect of each feature by gradually adding different components and evaluating their impact on the eMOC metric. Specifically, we may start by evaluating the source features and replacing the emotion token. Then, we may predict the unit durations and F0 for the target emotion. Lastly, the full effect of our method may be achieved by incorporating the unit translation model. For reference, we report results for the original recording, and resynthesized one (i.e., using source features only) and the target recording. Results are summarized in Table 4.

The results may suggest that our method is comparable to ground-truth recordings in terms of the perceived emotion. Interestingly, for the “sleepy” emotion, modifying the timbre using the target emotion-token and adjusting the unit durations is enough to reach 70.31%, while the rest of the emotions require further processing. For “amused”, “angry” and “disgusted”, modifying the F0 reaches performance of 5% below the ground-truth recordings. When applying the entire pipeline, the results are on par with the ground-truth. This may be explained by the addition and deletion of non-verbal vocalizations by the translation model.

TABLE 4

| | | | | eMOC | | | |
|---|---|---|---|---|---|---|---|
| | | | Dura- | | | Dis- | |
| Tokens | Emotion | F0 | tion | Amused | Angry | gusted | Sleepy |
| Original - Neutral | | | | 20.11 | 21.66 | 7.59 | 17.34 |
| src | src | src | src | 20.24 | 18.62 | 8.37 | 17.72 |
| src | tgt | src | src | 27.66 | 25.76 | 10.83 | 25.19 |
| stc | tgt | src | pred | 30.89 | 35.71 | 32.11 | 70.31 |
| src | tgt | pred | pred | 79.12 | 86.11 | 69.21 | 79.12 |
| pred | tgt | pred | pred | 85.16 | 90.61 | 75.89 | 84.23 |

| | | | | |
|---|---|---|---|---|
| Original - Neutral | 86.31 | 89.92 | 76.18 | 88.01 |

Effect of components in our system on perceived emotion. “Original - Neutral” denotes the ground-truth neutral recordings while “Original - Emotion” denotes the ground-truth emotional recording. “src”, “tgt”, and “pred” denote features extracted from source speech, features extracted from target speech, and features predicted by our system respectively.

Due to the size of the experimental speech corpus (7000 samples overall), the number of unique utterances is small. As a result, the model may memorize the utterances and may fail to generalize to unseen sentences. Hence, we experimented with converting out-of-domain recordings. To that end, we input our system with recordings from the experimental speech corpus. As the experimental speech corpus comprises non-expressive samples, we treat them as “neutral”. We convert these samples to different emotions and evaluate the performance. For evaluation, we randomly sampled 20 utterances converted to each emotion. Our method reaches an average eMOC score of 82.25%±7.32 and an average MOS score of 3.69±0.26 across all four emotions (amused, angry, disgusted, sleepy). When considering the lexical content, the WER between the ground-truth text and ASR based transcriptions of the generated audio is 27.92. These results are similar to the ones reported for the experimental speech corpus.

In particular embodiments, we evaluated three weight-sharing schemes for our model: (i) all emotions use the same encoder and decoder components of the Transformer architecture. In this case, we condition the model on the target emotion. This may be done by prepending a special target emotion token at the beginning of the decoding procedure. We denote this approach by “share-all”. (ii) All emotions share the same encoder but have separate dedicated decoders. In this case, no target emotion conditioning is needed. We denote this approach by “share-enc”. Finally, (iii) each emotion has a dedicated encoder and decoder. We denote this approach by “share-none”. We evaluated all three approaches and summarized the results in Table 5.

TABLE 5
Evaluation of three weight-sharing
schemes for the translation model.

| Architecture | BLEU | UER | WER | PER |
|---|---|---|---|---|
| Share-all | 31.97 | 42.56 | 25.47 | 26.44 |
| Share-enc | 32.22 | 41.16 | 23.91 | 25.41 |
| Share-none | 32.37 | 41.38 | 23.91 | 25.95 |

It may be seen that the share-enc and share-none architectures are comparable, while the share-all configuration is inferior. Although both share-enc and share-none configurations are similar in terms of lexical reconstruction, in our listening tests share-none generated more expressive speech.

We provide results for the F0 estimation module in Table 6. “Log” denotes applying the logarithm function before normalization.

TABLE 6
Evaluation of different F0 estimation configurations.
The MAE is reported for voiced frames only.

| Log | Quantization | Norm. | Prediction | MAE |
|---|---|---|---|---|
| X | uniform | X | argmax | 83.51 |
| X | uniform | X | w-avg | 44.92 |
| X | uniform | mean | argmax | 53.74 |
| X | uniform | mean | w-avg | 35.63 |
| X | uniform | mean-std | argmax | 63.01 |
| X | uniform | mean-std | w-avg | 35.69 |
| X | adaptive | X | argmax | 129.7 |
| X | adaptive | X | w-avg | 45.21 |
| X | adaptive | mean | argmax | 127.8 |
| X | adaptive | mean | w-avg | 36.06 |
| X | adaptive | mean-std | argmax | 155.7 |
| X | adaptive | mean-std | w-avg | 35.38 |
| ✓ | uniform | X | argmax | 62.69 |
| ✓ | uniform | X | w-avg | 67.40 |
| ✓ | uniform | mean | argmax | 52.24 |
| ✓ | uniform | mean | w-avg | 63.67 |
| ✓ | uniform | mean-std | argmax | 50.95 |
| ✓ | uniform | mean-std | w-avg | 51.25 |
| ✓ | adaptive | X | argmax | 127.9 |
| ✓ | adaptive | X | w-avg | 67.40 |
| ✓ | adaptive | mean | argmax | 110.4 |
| ✓ | adaptive | mean | w-avg | 54.21 |
| ✓ | adaptive | mean-std | argmax | 144.9 |
| ✓ | adaptive | mean-std | w-avg | 51.25 |

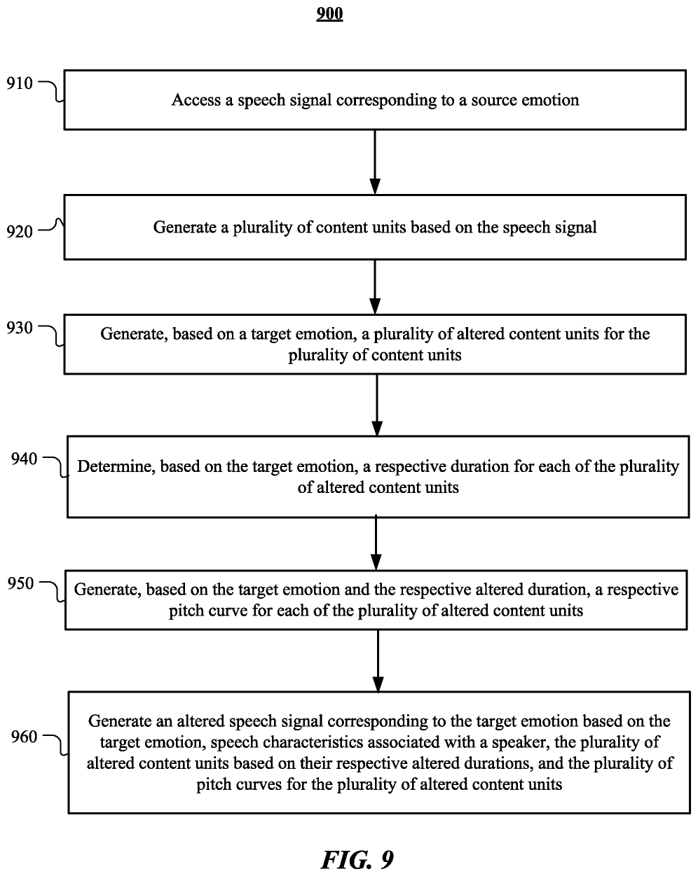

FIG. 9 illustrates an example method 900 for changing emotion in speech signals. The method may begin at step 910, where the speech-processing system may access a speech signal corresponding to a source emotion. At step 920, the speech-processing system may generate a plurality of content units based on the speech signal. At step 930, the speech-processing system may generate, based on a target emotion, a plurality of altered content units for the plurality of content units. At step 940, the speech-processing system may determine, based on the target emotion, a respective duration for each of the plurality of altered content units. At step 950, the speech-processing system may generate, based on the target emotion and the respective altered duration, a respective pitch curve for each of the plurality of altered content units. At step 960, the speech-processing system may generate an altered speech signal corresponding to the target emotion based on the target emotion, speech characteristics associated with a speaker, the plurality of altered content units based on their respective altered durations, and the plurality of pitch curves for the plurality of altered content units. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for changing emotion in speech signals including the particular steps of the method of FIG. 9, this disclosure contemplates any suitable method for changing emotion in speech signals including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

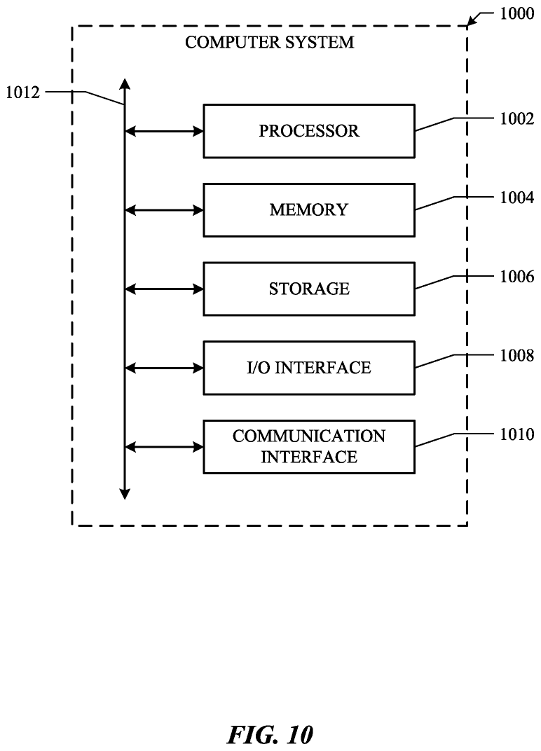

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
accessing a speech signal corresponding to a source emotion;
generating a plurality of content units based on the speech signal;
generating, based on a target emotion, a plurality of altered content units for the plurality of content units;
determining, based on the target emotion, a respective duration for each of the plurality of altered content units;
generating, based on the target emotion and the respective altered duration, a respective pitch curve for each of the plurality of altered content units; and
generating an altered speech signal corresponding to the target emotion based on the target emotion, speech characteristics associated with a speaker, the plurality of altered content units based on their respective altered durations, and the plurality of pitch curves for the plurality of altered content units.

2. The method of claim 1, wherein generating the plurality of altered content units comprises translating non-verbal vocalizations associated with the speech signal while preserving lexical content associated with the speech signal.

3. The method of claim 1, wherein the source or target emotion is based on one or more of a prosodic feature, a speaking style, or a non-verbal vocalization.

4. The method of claim 1, wherein the speech signal is based on an audio waveform, and wherein generating the plurality of content units comprises applying an encoder to the audio waveform.

5. The method of claim 4, wherein the encoder outputs a continuous spectral representation of the speech signal, wherein the method further comprises:
applying a clustering algorithm to the continuous spectral representation based on a size of a vocabulary associated with the speech signal.

6. The method of claim 1, wherein generating the plurality of altered content units comprises one or more of changing a content unit of the plurality of content units, adding a content unit to the plurality of content units, or deleting a content unit from the plurality of content units.

7. The method of claim 1, wherein the speech signal is associated with the speaker, wherein the method further comprises:
generating the speech characteristics for the speaker based on the speech signal.

8. The method of claim 1, wherein generating the plurality of altered content units is based on a sequence-to-sequence model.

9. The method of claim 8, wherein the sequence-to-sequence model comprises one encoder shared among a plurality of source emotions comprising the source emotion and one decoder shared among a plurality of target emotions comprising the target emotion.

10. The method of claim 8, wherein the sequence-to-sequence model comprises a plurality of encoders dedicated to a plurality of source emotions comprising the source emotion, respectively, and wherein the sequence-to-sequence model comprises a plurality of decoders dedicated to a plurality of target emotions comprising the target emotion, respectively.

11. The method of claim 8, wherein the sequence-to-sequence model comprises one encoder shared among a plurality of source emotions comprising the source emotion, and wherein the sequence-to-sequence model comprises a plurality of decoders dedicated to a plurality of target emotions comprising the target emotion, respectively.

12. One or more computer-readable non-transitory storage media embodying software that is operable when executed to:
access a speech signal corresponding to a source emotion;
generate a plurality of content units based on the speech signal;
generate, based on a target emotion, a plurality of altered content units for the plurality of content units;
determine, based on the target emotion, a respective duration for each of the plurality of altered content units;
generate, based on the target emotion and the respective altered duration, a respective pitch curve for each of the plurality of altered content units; and
generate an altered speech signal corresponding to the target emotion based on the target emotion, speech characteristics associated with a speaker, the plurality of altered content units based on their respective altered durations, and the plurality of pitch curves for the plurality of altered content units.

13. The media of claim 12, wherein generating the plurality of altered content units comprises translating non-verbal vocalizations associated with the speech signal while preserving lexical content associated with the speech signal.

14. The media of claim 12, wherein the source or target emotion is based on one or more of a prosodic feature, a speaking style, or a non-verbal vocalization.

15. The media of claim 12, wherein the speech signal is based on an audio waveform, and wherein generating the plurality of content units comprises applying an encoder to the audio waveform.

16. The media of claim 15, wherein the encoder outputs a continuous spectral representation of the speech signal, wherein the software is further operable when executed to:
apply a clustering algorithm to the continuous spectral representation based on a size of a vocabulary associated with the speech signal.

17. The media of claim 12, wherein generating the plurality of altered content units comprising one or more of changing a content unit of the plurality of content units, adding a content unit to the plurality of content units, or deleting a content unit from the plurality of content units.

18. The media of claim 12, wherein the speech signal is associated with the speaker, wherein the software is further operable when executed to:
generate the speech characteristics for the speaker based on the speech signal.

19. The media of claim 12, wherein generating the plurality of altered content units is based on a sequence-to-sequence model.

20. A system comprising: one or more processors; and a non-transitory memory coupled to the processors comprising instructions executable by the processors, the processors operable when executing the instructions to:
access a speech signal corresponding to a source emotion;
generate a plurality of content units based on the speech signal;
generate, based on a target emotion, a plurality of altered content units for the plurality of content units;
determine, based on the target emotion, a respective duration for each of the plurality of altered content units;
generate, based on the target emotion and the respective altered duration, a respective pitch curve for each of the plurality of altered content units; and
generate an altered speech signal corresponding to the target emotion based on the target emotion, speech characteristics associated with a speaker, the plurality of altered content units based on their respective altered durations, and the plurality of pitch curves for the plurality of altered content units.
